(19) United States
(12) Patent Application Publication
(10) Pub. No.: US 2007/0233591 A1
(43) Pub. Date: Oct. 4, 2007

(54) CREDIT ENHANCEMENT SYSTEMS AND METHODS

(75) Inventors: Robert W. Newton, San Francisco, CA (US); Martin Hughes, San Rafael, CA (US); Terrance Hodel, San Rafael, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/758,602

(22) Filed: Jun. 5, 2007

Related U.S. Application Data
(62) Division of application No. 10/360,557, filed on Feb. 6, 2003.

(51) Int. Cl. G06Q 40/00

(52) U.S. Cl. 705/36 R

(57) ABSTRACT

The present invention provides methods and systems for presenting financial and credit information to a customer. In one embodiment, the method includes receiving a credit worthiness report (CWR) for the customer, and providing the CWR to the customer. The method includes providing a list of selectable options to the customer, the options directed to at least one financial activity. A selected option is received from the customer, and a revised CWR is provided to the customer in response to the selected option. In this manner, the customer can examine how particular options or activities effect their credit worthiness.

### BACKGROUND OF THE INVENTION

This invention relates generally to the field of customer credit and loan management, and in particular, to methods and systems for presenting customers with credit, loan, and other financial information and credit enhancement options.

Individuals establish a credit history by paying bills, obtaining and paying back loans, applying for credit cards, and the like. Several credit reporting agencies exist which keep track of individuals' credit activities. The reporting agencies also may maintain a credit rating, credit score, and/or credit risk factor for individuals. When an individual applies for a loan, such as for purchasing a home, an automobile, or the like, the lender typically will check the individual's credit rating. The credit rating often effects the terms of the loan. For example, the more creditworthy the customer, the more favorable the loan rates offered to the customer. In contrast, a customer with a poor credit history constitutes a higher credit risk (risk of default, late payment, etc), and typically must pay higher interest rates to borrow money.

One measure used to determine a customer's credit risk is a Fair Isaac & Company (FICO) score. The FICO score takes into account a number of credit based factors, including past payment history, amount of credit owed, length of time credit has been established, the search for and acquisition of new credit, types of credit established, and the like. The customer's overall credit will be tabulated into a FICO credit score, which typically ranges from the 300's to the 800's. FICO credit scores above about 730 are deemed excellent credit risks. As a result, they typically receive loan offers at the most favorable rates. FICO credit scores below about 585 typically indicate a poor credit risk customer. Such customers may be turned down for most credit or loans. Customers having FICO credit scores between 585 and 730 have varying degrees of credit risk. These customers may, for example, be able to receive some credit, but not at the best rates.

Customers typically can receive a credit report by asking one of the credit reporting agencies. However, it would be desirable for customers to more readily access their credit report, and/or their FICO credit score, so they may assess their likelihood of receiving credit at favorable terms. Further, it would be desirable for customers to be able to assess which actions, or inactions, will improve their credit worthiness for future transactions.

### BRIEF SUMMARY OF THE INVENTION

The present invention provides methods for presenting financial and credit information to a customer. In one embodiment, the method includes receiving a credit worthiness report (CWR) for the customer, and providing the CWR to the customer. The method includes providing a list of selectable options to the customer, the options directed to at least one financial activity. A selected option is received from the customer, and a revised CWR is provided to the customer in response to the selected option. In this manner, the customer can examine how particular options or activities effect their credit worthiness.

In one aspect, the credit worthiness report is received from a credit reporting agency and provided to the customer. The CWR may be provided to the customer by email, by regular mail, by displaying on a web site accessible to the customer, and the like. Such a report includes, in one embodiment, a Fair Issac & Co. (FICO) score. In one aspect, the method includes calculating an estimated revised FICO score based on the selected option. Alternatively, the selected option may be reported to the credit reporting agency, with the credit reporting agency providing the revised CWR. The method may include, for example, transmitting a request for a CWR, or a revised CWR, to a credit reporting agency server. The method further includes receiving the CWR at a host computer and transmitting some or all of the CWR to a customer computer.

The list of selectable options can present a wide range of financial choices to the customer within the scope of the present invention. The options may be directed to one or more financial activities or goals, including, paying bills, paying off loans, purchasing items on credit, saving money for specific or general purposes, and the like. In one example, the customer's desired financial activity is to pay down a loan balance. In this case, the customer selects from a list of one or more options which will help to pay down the loan. In this example, the list of selectable options may include an equity acceleration program, a loan balance balloon payment, an automatic or on-time payment program, additional principal payments, or the like. In one method of the present invention, the customer can determine which option will reduce their CWR a desired amount. In one aspect, the revised CWR is displayed as a function of time. This may be useful, for example, if the selected option is an on-time payment program or some other program requiring multiple actions or payments over an extended period of time. In this manner, the CWR can be revised periodically (weekly, monthly, quarterly, etc.) and provided or made accessible to the customer.

Advantages of having an improved CWR include, but are not limited to, obtaining better loan rates for new loans, being available for lower loan rate refinancing on existing loans, the receipt of product and service offerings available to customers with certain CWR scores, and the like. In one aspect, the method includes offering a product to the customer based on the revised CWR. In a similar aspect, the method includes receiving a request from the customer to transmit an offer available to the customer based on the customer's revised CWR. The method may include transmitting a file comprising offers available to the consumer based on the CWR. The method may include receiving a request from the customer to filter certain of the offers.

The present invention further includes systems for presenting financial and credit information to a customer. In one embodiment, the system includes a processor and a storage medium coupled to the processor. The storage medium has a computer-readable program embodied therein. The program includes code adapted to receive the CWR, provide the CWR and a list of selectable options to the customer, receive a selected option from the customer directed to at least one financial activity, and provide a revised CWR to the customer in response to the selected option. In a particular embodiment, the code is further adapted to calculate an estimated revised CWR based on the selected option.

In some embodiments, a host computer comprises the processor and storage medium. In this manner, the host computer provides the CWR to the consumer. This may occur, for example, by transmitting the CWR to a customer computer. Alternatively, the CWR may be posted on a customer-accessible web site. In some embodiments, the customer computer is linked to a credit reporting agency computer, a client computer, a realtor computer, and the like.

In another embodiment of the present invention, a method of presenting financial information to the customer includes displaying a loan value of a loan, with the loan based on an asset having an asset value. The asset value also may be displayed. The method includes calculating a ratio of the loan value to the asset value, and informing the customer when the ratio is at a desired amount. This method will be useful for a variety of loans and assets, including for loans on residential property, commercial property, personal property, and the like. In some embodiments, the loan value includes a principal portion of a mortgage, a buyout payment for the mortgage, and the like.

Such a method will be particularly useful for determining the amount of equity a customer has in the asset. This method may be used, for example, to determine when a homeowner has a desired amount of equity in their home. On many occasions, the mortgagee requires that the homeowner maintain mortgage insurance if the equity in the home is below a certain level. The mortgage insurance typically is paid on a regular basis, such as monthly, as part of the mortgage payment. When the equity in the home exceeds a certain level, such as ten (10) percent, twenty (20) percent, or the like, the homeowner can have the mortgage insurance removed. In this manner, the mortgage payment is reduced. Alternatively, some or all of the money saved by no longer paying mortgage insurance can be applied to the loan principal, further increasing equity in the asset.

A customer obtains equity in their asset, such as their residence, by some combination of a down payment upon purchase of the asset, paying down the loan principal, and/or appreciation of the asset fair market value. In one aspect of the invention, the loan principal payments are tracked. When the principal portion of the loan falls below a desired percent of the asset value, the customer is notified. In some aspects, the desired percentage is about ninety (90) percent, about eighty (80) percent, or the like.

In one embodiment, the asset value is set at the purchase value (e.g., the original asset appraisal), or the asset purchase price. In another embodiment, an asset value is calculated, or recalculated, in order to determine the loan value to asset value ratio. In a particular embodiment, the asset value is retrieved from a data base. The data base may include a real estate appraisal of the asset. This may be available, for example, from state or local tax authorities in charge of assessing real property taxes based on a value of the real property. In another aspect, the asset value is determined by using asset values for similar assets. For example, in one embodiment the method includes accessing a realtor database, retrieving a similar asset value for a similar asset, and displaying the similar asset value as the asset value. This may be accomplished, for example, by using the value of a residential property that is similar to the customer residential property to estimate the asset value of the customer residential property. This may occur, for example, by using the sale price of one or more assets (e.g., homes) that are similar to the customer asset.

In one embodiment, a method of the present invention includes displaying a list of selectable options directed to a reduction of the loan value. The method includes receiving a selected option from the list of selectable options and calculating a ratio of the loan to asset value based on the selected option. Again, the list of options may include a number of different choices, including an additional principal payment option. In one aspect, the method includes informing the customer of an estimated or actual date when the ratio would be at a desired amount.

In one embodiment, a system for presenting financial information to a customer includes a processor and a storage medium coupled to the processor. The storage medium has a computer-readable program embodied therein. The program includes code adapted to display a loan value of a loan, with the loan based on an asset having an asset value. The code is further adapted to display the asset value, calculate a ratio of the loan value to asset value, and inform the customer when the ratio is at a desired amount.

In one aspect, the program code is also adapted to display a list of selectable options, with the options directed to a reduction of the loan value. The code further is adapted to receive a selected option from the list of selectable options, and calculate the loan value based on the selected option. In another aspect, the program further includes code adapted to access a realtor database, retrieve a similar asset value for at least one similar asset, and display the similar asset value as the asset value.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components.

FIG. 1 illustrates a system for presenting credit and financial information to customers according to embodiments of the present invention;

FIG. 2 illustrates a method of presenting credit and financial information to customers according to an embodiment of the present invention, which may be implemented in the system of FIG. 1;

FIGS. 3A-3D illustrate a series of screen displays in a system for allowing customers to receive credit and financial information according to the present invention;

FIG. 4 illustrates another method of presenting credit and financial information to customers according to embodiments of the present invention; and

FIGS. 5A-5B illustrates a series of screen displays in a system for allowing customers to receive credit and financial information according to another embodiment of the present invention.

### DETAILED DESCRIPTION OF THE INVENTION

Customers establish a credit history by a wide range of activities. For example, obtaining and using credit cards establishes a credit history, as does timely paying the credit card bill or statement. A series of timely payments generally reduces the customer's credit risk, and may result in more favorable credit card interest rates, a higher credit limit, and the like.

Credit services may be established with essentially any type of person, entity, organization, business, or the like that wishes to take payments for goods or services in the form of a credit, and, for convenience of discussion, are generally referred to herein as “merchants.” Such merchants may process a credit transaction based on an account identifier presented at the time of payment. The account identifier is used to identify the account to which the credit will eventually be posted. In many cases, the account identifier is provided on some type of presentation instrument, such as a credit card, debit card, smart card, stored value card, or the like. Conveniently, the account identifier may be read from a point of sale device, such as those described in copending U.S. application Ser. Nos. 10/116,689, entitled “SYSTEMS AND METHODS FOR PERFORMING TRANSACTIONS AT A POINT-OF-SALE,” filed Apr. 3, 2002, by Earney Stoutenburg, et al., the complete disclosure of which is herein incorporated by reference. However, the account identifier may be obtained in other ways, such as by visual inspection of the presentation instrument, by telephone, over the Internet, and the like.

The user account information is transmitted to a credit processing service that approves and processes the transaction information and provides payment to the merchant. The credit processing service includes at least one platform server that receives and processes the transaction information. One example of a credit processing service is the service provided by First Data Corporation, Greenwood Village, Colo.

The credit processing organization may provide credit processing services on behalf of many clients, such as banks, or other financial institutions, and the like, who wish to issue credit accounts to their customers. The customers may then use the accounts to transact with merchants. Periodically, the credit processing organization produces financial statements that summarize transactions for customers and bill the customers at least a minimum amount based upon their usage of the credit account. The financial statements must be presented to the customer so that the customer may render payment. Methods and systems for presenting financial statements to the customer are more fully described in U.S. application Ser. No. 10/180,251, entitled FINANCIAL STATEMENT PRESENTMENT SYSTEMS AND METHODS, filed Jun. 25, 2002, the complete disclosure of which is incorporated herein by reference.

Another activity which effects a customer's credit rating involves borrowing, and paying back, a loan. Borrowed money often is used to help purchase property, such as residential property, and motorized vehicles. The lender may be the property seller or a third party. In either instance, the customer typically has a prescribed period of time to pay the borrowed money or loan principal, plus any accrued interest, loan origination fees, service fees, late fees, and the like. The interest rate charged by the lender can vary widely, and often depends at least partially on the customer's credit rating or credit worthiness. The present invention provides systems and methods for presenting financial and credit information to customers on behalf of clients, merchants or lenders. The present invention further enables the customer, client, merchant or lender to determine which activities can be undertaken to improve a customer's credit worthiness.

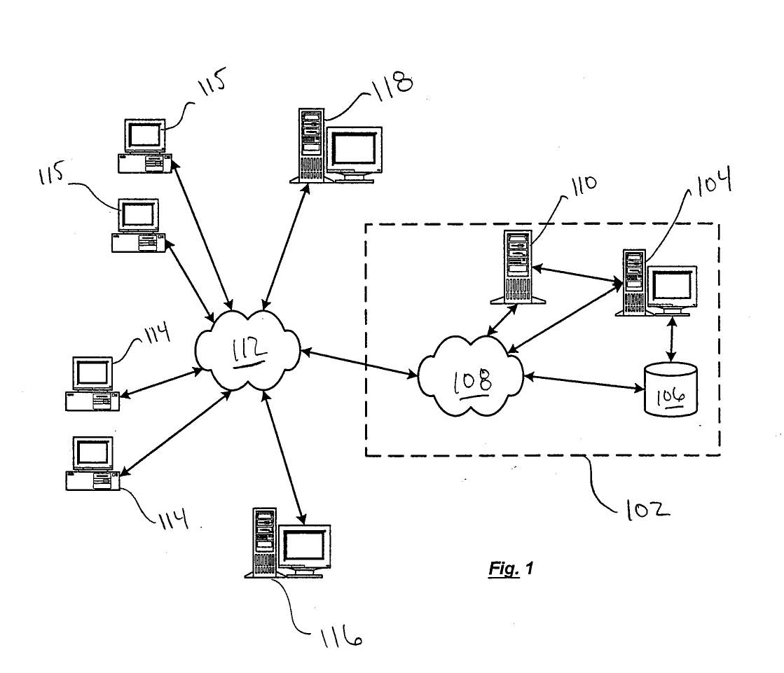

FIG. 1 illustrates one example of a system 100 for presenting financial or credit information to consumers according to embodiments of the present invention. It is to be understood that system 100 is presented for illustrative purposes only, and many other embodiments and equivalents are apparent to those skilled in the art in light of the disclosure herein. System 100 includes a host computer system 102. Host computer system 102 includes a server 104 and a database 106 associated with server 104. Server 104 may be any of a wide variety of well-known computing devices, including, for example, a personal computer, a workstation, a mainframe, a server, and the like. Database 106 may be any of a wide variety of storage devices, including, for example, magnetic storage systems, such as tape or disk, optical storage systems, such as CD or DVD systems, and solid state systems, such as RAM or ROM, and the like. Server 104 may be electrically connected for communication directly to database 106. Alternatively or additionally, server 104 and database 106 may communicate via a network 108. Network 108 may be any of a wide variety of network configurations, such as, for example, an intranet or a portion of the Internet. Network 108 may be, for example, a local area network (LAN), a wide area network (WAN), or the like.

Host computer system 102 may also include a financial processing computer 110. Financial processing computer 110 may be any of a wide variety of well known computing devices. Computer 110 may operate to process financial statements, receive credit worthiness report requests, present options to the customer, revise and/or receive revised CWRs, and the like. Computer 110 may be connected to server 104 directly or via network 108. Many additional computing and data collection platforms (not shown) may be connected with the host computer system and/or be comprised by portions of it. For example, computers and databases may collect and store transaction information relating to activity for which financial or credit information are produced.

FIG. 1 also illustrates an external network 112 connected with host computer system 102. External network 112 may be, for example, the Internet or other network environment. Through external network 112, customers are able to connect with host computer system 102 using, for example, customer computers 114. Clients, such as lenders, mortgage companies, finance companies and the like, are also able to connect to host computer system 102 using, for example, a client computer 115. FIG. 1 also illustrates a credit reporting agency server 116 connected to host computer system 102 via external network 112. Credit reporting agency server 116 may include one or more computers from which a customer may obtain information such as a FICO (Fair Isaac & Co.) credit score, credit worthiness reports, and the like. Additionally, a real estate computer 118 may be coupled to host computer system 102 directly or via external network 112. Real estate computer 118 can be a computer, server, database, and the like containing real estate sales and listing information, property tax information, or the like. Real estate computer 118 may be maintained by a third party, such as a government organization in charge of assessing real property tax, or a realtor office or association which tracks sale prices of real estate or other assets.

Having described the configuration of system 100, the general operation of system 100 will be described. More specific operation of system 100 will be described hereinafter with reference to the remaining figures. Financial and credit information is collected and stored using computers and storage devices associated with host computer system 102. Periodically, some financial transactions may be processed into financial statements for each customer by financial processing computer 110. This may occur, for example, for the issuance of financial statements directed to credit cards, debit cards, and the like. System 100 also may be used to present utility bills, phone bills, brokerage account statements, and the like. The financial statements may be delivered electronically, as paper statements, or both.

Further, host computer system 102 also may maintain financial information related to loans. For example, loan customers may access host computer system 102 using customer computers 114 to provide a loan implementation profile, to view financial, credit and loan information, and the like. Customers also may select options directed to desired financial activities, such as paying off the loan. Customer information is stored in database 106, for access by the customer, server 104 and/or financial processing computer 110. If a customer elects to receive their financial or credit information electronically, server 104 or processing computer 110 may cause an email to be sent to the appropriate customer computer 114. The customer also may access the financial or credit information by connecting to host computer system 102.

As the customer is viewing their statement or financial or credit information, host computer system 102 may present the customer with an option for requesting a credit worthiness report (CWR). If the customer requests a CWR, host computer system 102 may send a request to credit reporting agency server 116 and receive the report. Host computer system 102 then sends the report, or a portion of the report, to the customer. Alternatively, host computer system 102 makes the report accessible to the customer, such as by posting on a password protected website. Alternatively, selecting the option to receive a CWR may link the customer directly to credit reporting agency server 116 for interaction therewith.

Additionally, host computer system 102 may send the customer offers available to the customer based on the customer CWR. Such offers may include extended grace periods, low or no interest promotions, mortgage or auto loans, and the like. In some embodiments, the customer may have the option of either electing to receive offers or electing not to receive offers. In a specific embodiment, the customer may elect to filter certain offers. For example, a customer may wish not to receive offers intended for customers with sub-par credit ratings when their credit is outstanding, or they may wish to receive only offers for lower mortgage rates, or the like. This process has the advantage of providing the credit processing organization with enhanced marketing opportunities to reach customers directly and provide offers based on partial credit underwriting criteria. Other examples and benefits also exist.

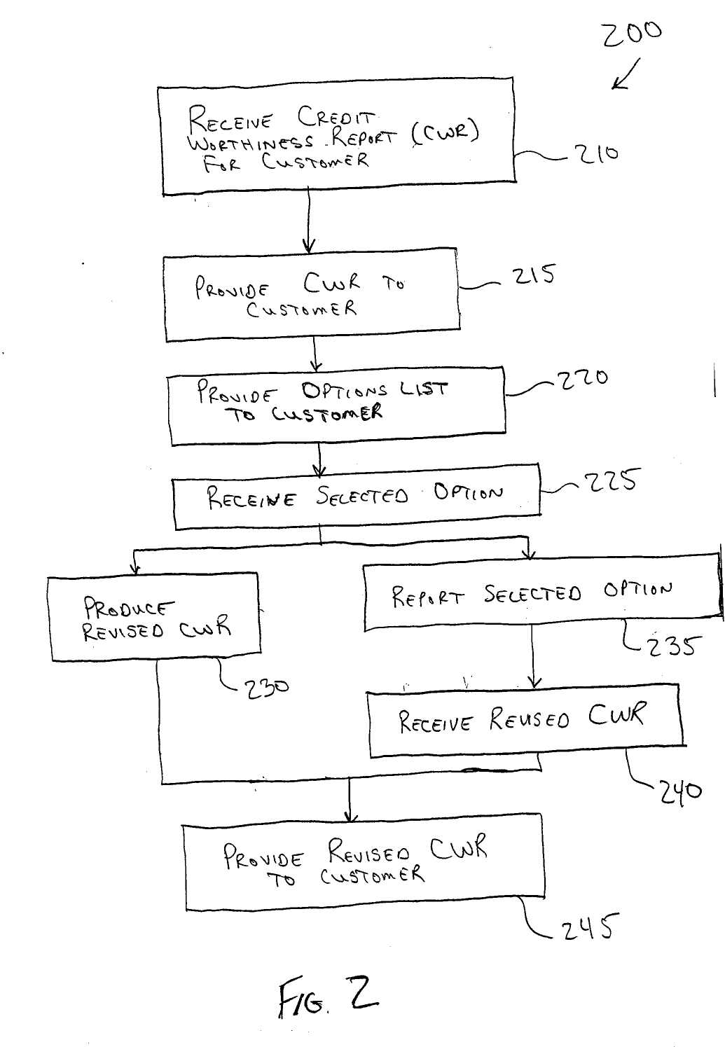

Turning now to FIG. 2, a method of presenting credit information to a customer according to the present invention will be described. Method 200 includes receiving a customer credit worthiness report (CWR) (block 210). Receipt of the CWR may result from the customer requesting such a report as previously noted. Alternatively, a credit report may be periodically provided. Once received, the CWR or a portion thereof is provided to the customer (block 215). Again, providing the CWR to the customer may result from a customer inquiry, or occur periodically. The CWR may be provided to the customer in a variety of ways. For example, the CWR may be embodied in a computer file which is transmitted to customer computer 114. Alternatively, the CWR may be posted on a web site accessible to the customer upon entry of a customer identification and password. Still further, an email or other message may be transferred to the customer indicating that the CWR is available by telephone, by website, by mail, or the like.

Method 200 further includes providing a list of options to the customer (block 220). The list of options are preferably directed to at least one financial activity. For example, the financial activity of interest to the customer may involve reducing a loan balance or loan principal. Thus, the list of options would provide a series of choices for the customer to select which result in a lower loan principal or loan balance. In this particular example, one such option may be an on-time payment program whereby the customer sets up an electronic transfer of a monthly or regular payment from the customer's bank account, checking account, savings account, or the like, to the lender's account. An alternative option may include, for example, the selection of an equity accelerator program. The equity accelerator program may involve, for example, the customer making a payment every two weeks that is equivalent to one-half of a monthly payment. Over the course of a twelve-month period, this results in twenty-six (26) payments, or the equivalent of thirteen (13) typical monthly payments. As a result, in the one-year period, the equivalent of one additional monthly payment has been made towards reducing the loan principal. Other options directed to reducing a loan balance also may be included, as will be appreciated by those skilled in the art.

The method includes receiving the selected option (block 225), and using the selected option to update or revise the CWR. In one embodiment, a revised CWR is produced (block 230) using algorithms maintained in server 104 or processing computer 110. The algorithms may be identical to those used by credit reporting agencies, providing an accurate revised CWR. Alternatively, the algorithms used produce an estimated revised CWR. The revised CWR is provided to the customer (block 245).

In another embodiment, the selected option is reported (block 235) to a credit reporting agency. For example, the selected option may be transmitted to credit reporting agency server 116. The credit reporting agency updates or revises the CWR based at least in part on the selected option. The revised CWR is received (block 240), and then provided to the customer (block 245). Again, providing the revised CWR to the customer can entail emailing the customer to inform them the revised CWR is available, sending the revised CWR or a portion thereof to the customer, posting the revised CWR on a website accessible to the customer, or the like. In this manner, the customer can readily determine how activities or selected options will effect their credit worthiness.

In some embodiments, more than one option may be elected by the customer. In these cases, the revised CWR reflects the effect of more than one option. In other embodiments, the method includes providing a graphical, numerical, or other depiction of the revised CWR for one or more selected option(s). In this manner, the customer can readily determine which selected option or activity will effect the CWR a desired amount, or the most.

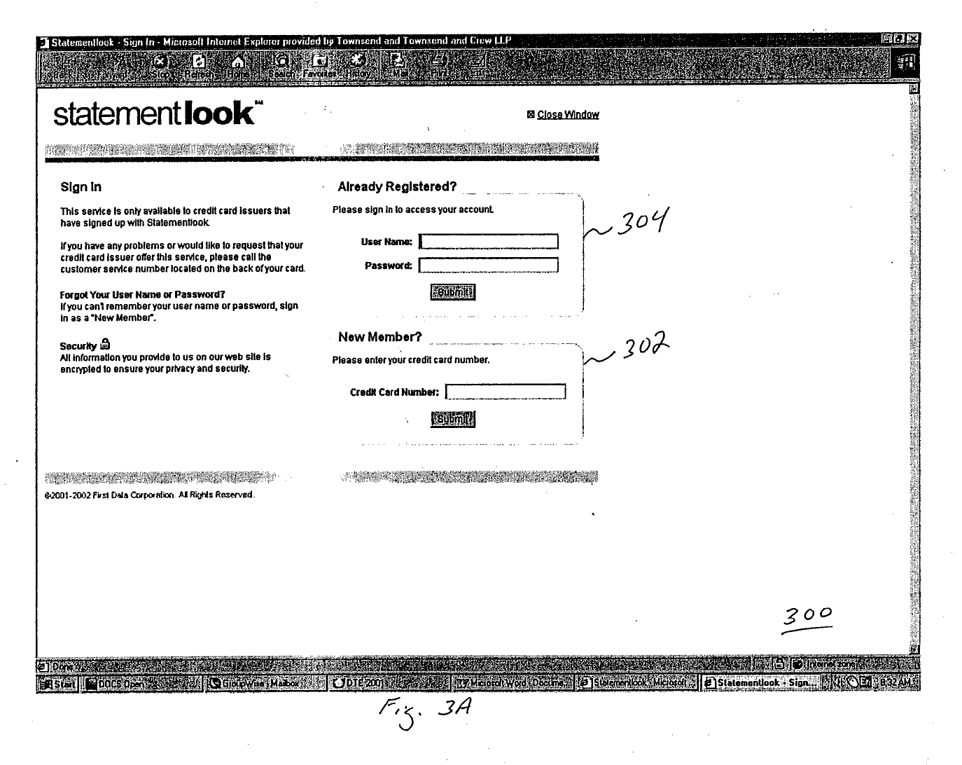

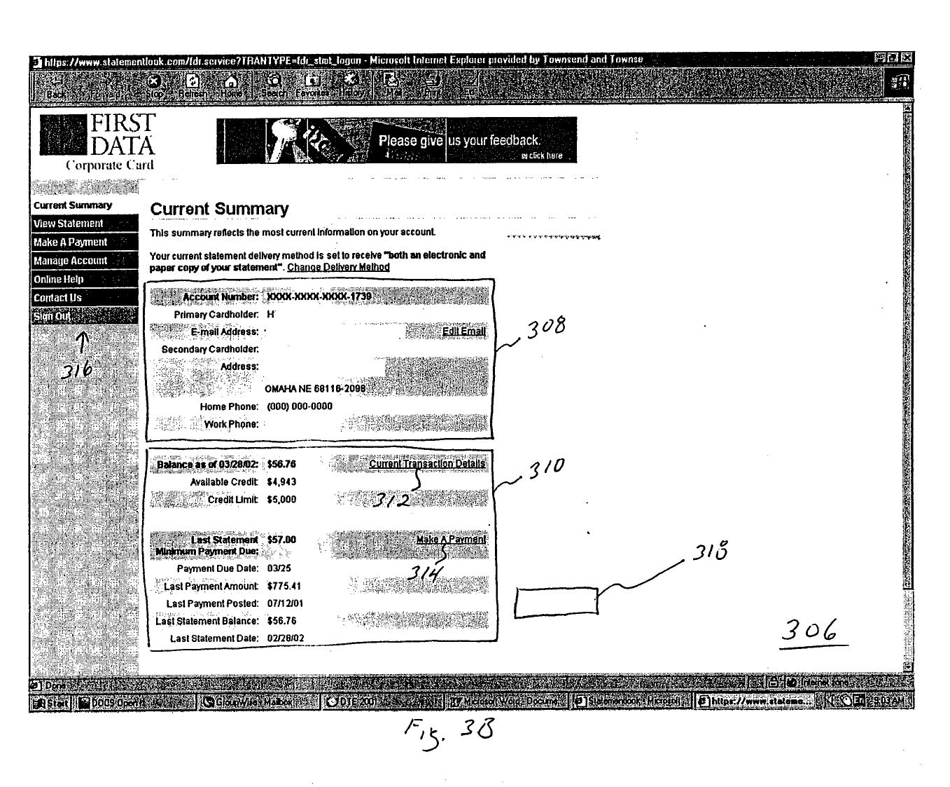

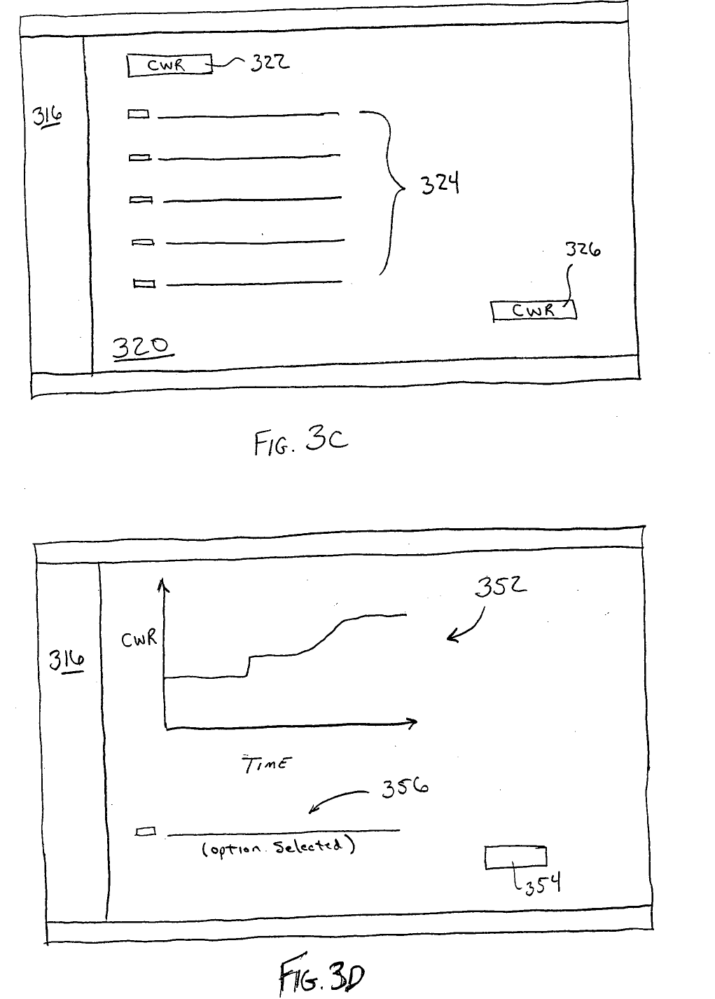

Turning now to FIGS. 3A-3D, one example of screen displays a customer may view to access and view financial and credit information will be provided. Many other possible screen displays also may be used within the scope of the present invention. The screen displays are illustrated within a typical web browser environment with familiar web browser navigation features. FIG. 3A illustrates a typical sign-in screen display 300. Screen display 300 includes a new member area 302, and an existing member area 304. In some embodiments, new members enter a credit card number into the field provided. If the credit card account is valid, the new member is approved for online activity and taken through a registration process wherein the new user receives a user name and password. In other embodiments, the new member enters an account number, or some other unique identifier (client provided identification, social security number, etc.) to begin the registration process. Standard security features may be provided for ensuring the account is only accessed by the user, or by persons authorized to access the account by the user. If the customer is an existing member, the customer enters their user name and password. Once valid information is provided, customers are taken to a summary screen 306, illustrated in FIG. 3B.

Summary screen 306 includes a basic information section 308 that identifies the account, the account holder and the account holder's contact information. Summary screen 306 also includes a financial statement area 310 that lists the customer's credit or financial information. In one embodiment, the customer's current balance, available credit and credit limit for a credit card account are displayed, as more fully described in U.S. application Ser. No. 10/180,251, entitled FINANCIAL STATEMENT PRESENTMENT SYSTEMS AND METHODS, the complete disclosure of which has been previously incorporated herein by reference. Additionally, financial statement area 310 lists information relating to the previous statement, the payment received, the amount due, and other relevant information.

A button 312 allows the customer to view detailed transaction information. A second button 314 allows the customer to make a payment on line. A navigation area 316 includes additional buttons that allow the customer to access features of the site. In some embodiments, a credit score button 318 allows a customer to request a creditworthiness score from a credit reporting agency. This feature will be described in more detail hereinafter with reference to FIGS. 3C-3D.

Further, in some embodiments, the system presents the customer with a “payoff estimator” that allows the customer to calculate the time and cost to pay off any one or combination of account or loan balances based on a specified payment. The customer then may adjust the payment to evaluate alternatives for paying the balance(s) off according to different payment schedules. If desired, the customer may make a payment online, make a cash payment using a wire transfer, make a cash payment at a money transfer location, or send a payment by mail. Additionally, the customer may select to receive financial statements, offers, CWRs, and updates thereof online. In this case, the desired information may be printed to a file and sent to customer computer 114. Alternatively, an email is sent to the customer alerting the customer that their information is available online. If the customer has selected to receive information by regular mail, then the requested information is printed to paper and mailed to the customer. Of course, the customer also may receive information both online and by mail. Many other examples are possible.

Turning now to FIG. 3C-3D, one example of screen displays for depicting customer credit information will be described. As shown in FIG. 3C, a screen display 320 depicts a current credit worthiness report (CWR) or credit score in a display area 322. In one embodiment, the credit score is a FICO score. Screen display 320 includes a list of selectable options 324. One or more options 324 may be selected by clicking on the desired option, or on a box adjacent the option. In one embodiment, selecting an option produces an updated CWR 326. This may occur, for example, by recalculating a FICO score based on the selected option, and displaying the revised FICO score as shown in FIG. 3C. It will be appreciated by those skilled in the art that the CWR and revised CWR may contain a FICO score, or some other indicator of credit risk. For example, the CWR may contain credit risk categories for customers such as “LOW RISK,” “MEDIUM RISK,” “HIGH RISK,” and the like.

Alternatively, in another embodiment, selecting one or more options 324 launches a new screen display, such as that shown in FIG. 3D, for depiction of the revised CWR. For example, FIG. 3D depicts a graph 352 of a customer's CWR or credit worthiness score as a function of time. This may occur, for example, from the present time showing the current CWR, and a representation of how the credit worthiness score would change over time based on the selected option. The selected option may be shown in display area 356 for convenient reference. Further, based on the revised or updated CWR, the user may select button 354 which launches a list of offers available to the customer based on the revised CWR. For example, the customer may have access to improved loan rates for existing loans due to an improved CWR. Similarly, additional products and services may be available to the customer based on the improved CWR. In another embodiment, graph 352 may depict how a combination of selected options effects the customer CWR. In still another embodiment, graph 352 depicts more than one curve, with each curve representative of an option. In this manner, the customer can readily determine which option would most effect their CWR. While FIG. 3D depicts a two-axis graph, the invention is not limited as such, since other visual indicators may be used to display the CWR.

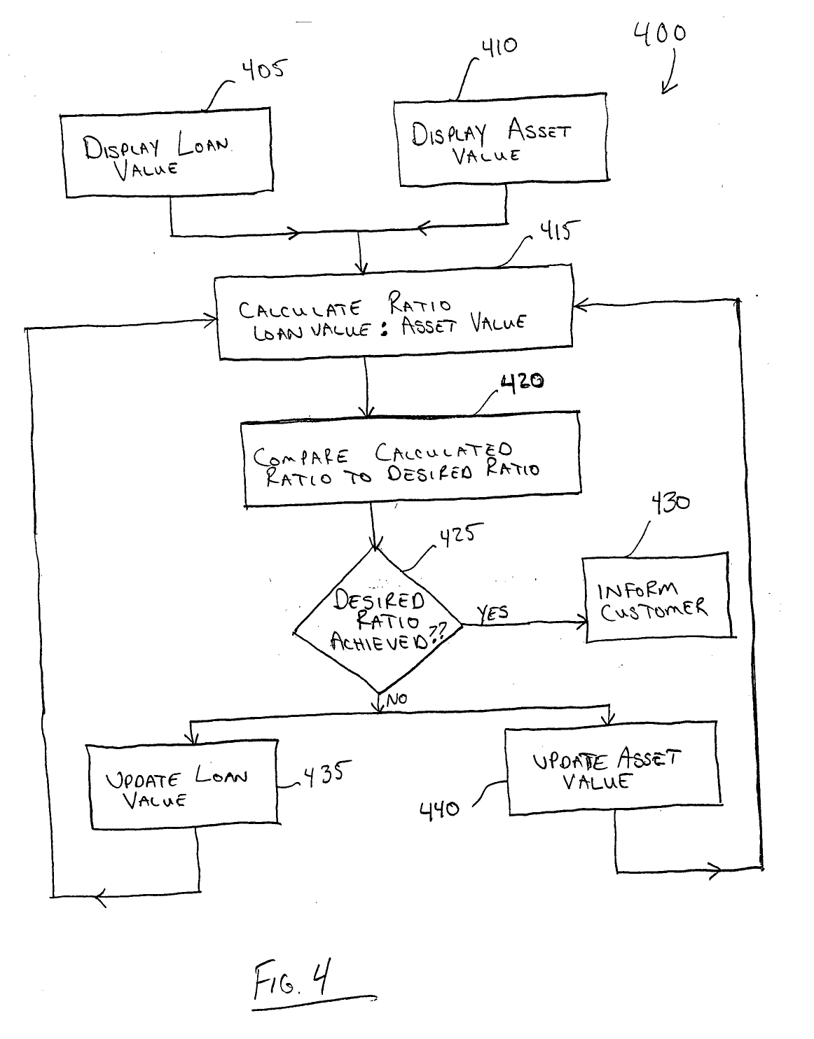

Turning now to FIG. 4, another method of displaying credit information to the customer will be described. Method 400 includes displaying a loan value (block 405) and displaying an asset value (block 410). The loan value and asset value may comprise, in one example, the principal portion of a mortgage and a value of the residence or property that has been mortgaged. In another embodiment, the loan value is based on a payoff amount for the loan in the event the consumer wishes to pay off the loan in its entirety. This may differ, for example, from the present loan principal. The loan value and asset value are used to calculate a ratio of the two (block 415). The calculated ratio is then compared to a desired ratio (block 420). This may be useful, for example, to determine when a loan value falls below a certain percentage of the asset value. For example, in some mortgages of residential property, the mortgagee requires the customer have mortgage insurance in the event the loan value exceeds eighty percent (80%) of the home value. This may occur, for example, if the customer did not put a twenty percent (20%) downpayment upon purchase. It will be appreciated by those skilled in the art that other desired ratios also fall within the scope of the present invention.

The method includes determining if the desired ratio has been achieved (decision 425). If the desired ratio has been achieved, the customer is informed (block 430). The customer is informed, for example, by sending the customer an email, a page or other electronic message, by identifying the customer for receipt of a telephone call confirming the desired ratio has been achieved, and the like. If the desired ratio has not been achieved, method 400 includes updating the loan value and/or asset value.

Updating the loan value (block 435) may include the selection of one or more options by the customer. For example, if the customer elects to enter an equity acceleration program, requiring a payment every two weeks (26 per year) equal to one-half of a monthly payment, the loan principal will be reduced more quickly than for twelve monthly payments. This updated loan value then is used to recalculate the loan value to asset value ratio to determine if such a program will achieve the desired ratio. Particularly for options which require multiple payments over time, the customer can readily see how many additional payments or principal payments must be made prior to achieving the desired ratio. The loan value also may be updated through the selection of other options, for example, a loan balance balloon payment, an automatic or on-time payment program, additional principal payments, or the like.

Alternatively, or in addition, the asset value is updated (block 440). The asset may be updated a number of different way. In one embodiment, computer system 102 is linked to server 118 containing asset valuations for a variety of customers assets. In a particular example, where the assets are residential properties, the server 118 may contain real estate appraisal data for residences in the customer's geographical area. Server 118 may be a government server in this example. Typically, local communities, townships, counties, states and the like access real property tax on the property owners. The real property tax is typically based on an assessed value of the property, which may be updated periodically. Thus, in one embodiment of method 400, computer system 102 couples with server 118 to obtain the most recent asset value for the customer's residence. The loan value to asset value ratio is recalculated (block 415) to determine if the desired ratio has been achieved.

In another embodiment of the present invention, the updated asset value is determined by comparing a similar asset to the customer's asset. The similar asset value then can be used as the customer asset value.

In a particular example, where the customer asset is real property, the comparison may be made between the customer's property and similar properties. This may occur, for example, by computer system 102 linking with server 118, whereby server 118 includes, or is coupled to, a realtor database. The realtor database may contain listing and/or sales data for a plurality of properties, some of which are similar to the customer property. What constitutes a “similar asset” or “similar property” may be determined in a variety of ways, using a wide range of criteria. For example, updating asset value in block 440 may comprise obtaining a record of all property sales in the customer's neighborhood, and averaging the sale prices to estimate the customer's property value. In another example, one or more homes having similar sizes (e.g., square footage), built within a certain number of years of customer's home (e.g., within two years), and sold within the last X months (e.g., twelve months), can be used to estimate the customer's home value.

Once the similar asset value or average value has been determined, this value may be used as an estimate for the customer's asset. If the number of similar assets is greater than one, the sale prices of the similar assets may be averaged, with the average used for the customer's asset value. It will be appreciated by those skilled in the art that the above examples comprise just a few of a large number of examples for determining a similar asset value, which in turn may be used for the asset value for the customer.

While updating the loan value and updating the asset value have been described separately, it will be appreciated by those skilled in the art that both may be updated prior to recalculating the loan value to asset value ratio.

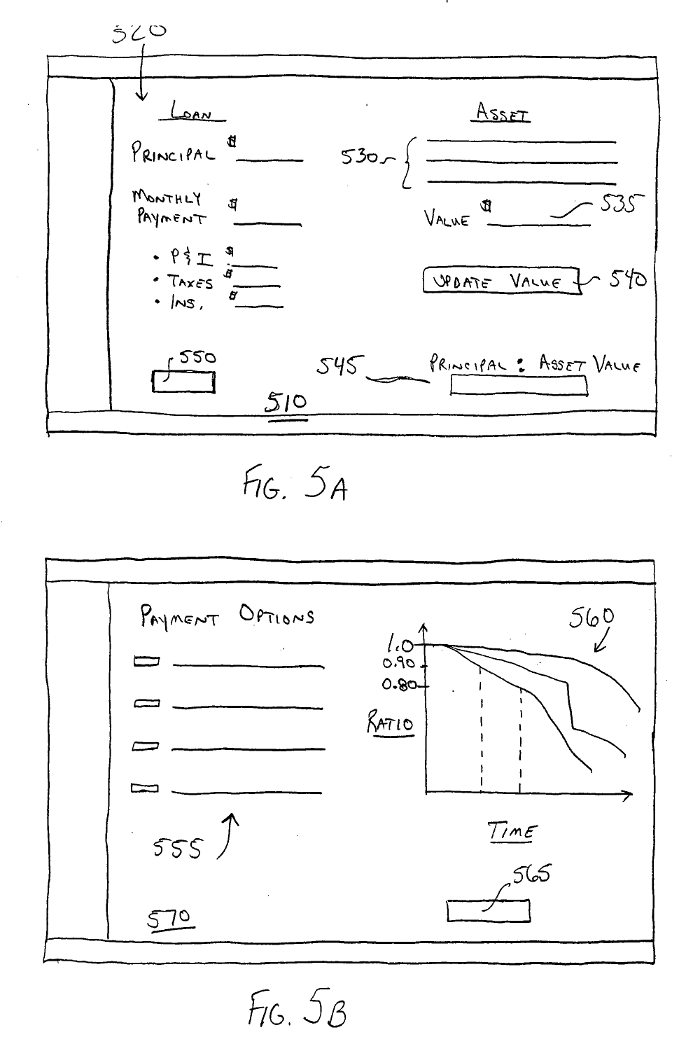

Turning now to FIGS. 5A-5B, one embodiment of screen displays for implementing method 400 will be described. Many other possible screen displays also may be used within the scope of the present invention. As shown in FIG. 5A, screen display 510 includes a screen area 520 which depicts information on one or more loans. Loan information may include the current loan principal, the monthly payment to be made against the loan, and the like. The monthly payment may further be broken out by principal and interest, taxes, mortgage insurance, and the like. Screen 510 also includes a screen area for asset information. This area may present an asset description 530, a present asset value 535, and the like. The current loan value to asset value ratio is depicted in screen area 545 of screen display 510. As noted in conjunction with FIG. 4, it may be desirable to update the loan value, the asset value, or both. This can occur, for example, by clicking on a button 550, and/or a button 540 to update the loan value and asset value, respectively.

Selecting or clicking button 550, in one embodiment, launches a new screen display 570 as shown in FIG. 5B. Screen display 570 presents a list of payment options 555. List of payment options 555 preferable includes a list of selectable options for the customer to achieve a financial objective. In one embodiment, the list of options are directed to reducing a loan principal. For example, one option may comprise entering an equity accelerator program as previously described. Another option may involve the payment of additional principal payment for a set number of months. For each payment option selected, the loan value to asset value ratio is recalculated and displayed in screen area 560. In one embodiment, screen area 560 depicts a chart showing how the ratio changes as a function of time. In this manner, a graphical depiction of the calculated ratio is shown so that the customer can determine when the desired ratio will be achieved. It will be appreciated by those skilled in the art that while a two-axis graph is depicted in FIG. 5B, other graphical depictions also may be used within the scope of the present invention, including, pie charts, bar graphs, and the like.

In one embodiment, FIG. 5B also includes a button 565 for the customer to click in the event the desired ratio is achieved. Button 565 may be desirable, for example, to facilitate removal of mortgage insurance from their mortgage payment. Clicking button 565 would request that the appropriate papers be sent to the customer.

Selecting button 540 operates to update the asset value. This may occur in a number of ways within the scope of the present invention. For example, selecting button 540 may result in computer 110 linking with server 118 to obtain the most recent tax assessment of the asset. Alternatively, selecting button 540 may result in computer 110 linking with server 118 to receive a similar asset value for use as the customer asset value. Selecting button 540 may, but need not, launch a new screen display. In one embodiment, selecting button 540 to update the asset value launches a new screen (not shown) wherein the user can select the method by which the asset value is to be updated.

Having described several embodiments, it will be recognized by those of skill in the art that various modifications, alternative constructions, and equivalents may be used without departing from the spirit of the invention. Additionally, a number of well known processes and elements have not been described. For example, those skilled in the art know how to arrange computers into a network and enable communication among the computers. Accordingly, the above description should not be taken as limiting the scope of the invention, which is defined in the following claims.

1-15. (canceled)

16. A method of presenting financial information to a customer, the method comprising:
displaying a loan value of a loan, the loan based on an asset having an asset value;
displaying the asset value;
calculating a ratio of the loan value to asset value; and
informing the customer when the ratio is at a desired amount.

17. The method as in claim 16 wherein the loan comprises a mortgage, and the loan value comprises a principal portion of the mortgage.

18. The method as in claim 16 wherein the loan comprises a mortgage, and the loan value comprises a buyout payment for the mortgage.

19. The method as in claim 16 wherein the asset comprises a residential property.

20. The method as in claim 16 wherein the asset comprises a commercial property.

21. The method as in claim 16 wherein the asset comprises a personal property.

22. The method as in claim 16 further comprising retrieving the asset value from a data base, the asset value comprising a real estate appraisal of the asset.

23. The method as in claim 22 wherein the real estate appraisal comprises an appraisal for real estate tax purposes.

24. The method as in claim 16 further comprising:
accessing a realtor database;
retrieving a similar asset value for a similar asset; and
displaying the similar asset value as the asset value.

25. The method as in claim 24 wherein the asset comprises a residential property and the similar asset comprises a similar residential property.

26. The method as in claim 16 further comprising:
displaying a list of selectable options, the options directed to a reduction of the loan value;
receiving a selected option from the list of selectable options; and
calculating the loan value based on the selected option.

27. The method as in claim 26 wherein the list of options comprises an additional principal payment option.

28. The method as in claim 26 wherein informing the customer further comprises informing the customer of an estimated date when the ratio would be at a desired amount.

29. A system for presenting financial information to a customer, the system comprising:
a processor; and
a storage medium coupled to the processor, the storage medium having a computer-readable program embodied therein, the program including code adapted to:
display a loan value of a loan, the loan based on an asset having an asset value;
display the asset value;
calculate a ratio of the loan value to asset value; and
inform the customer when the ratio is at a desired amount.

30. The system as in claim 29 wherein the program further includes code adapted to:
display a list of selectable options, the options directed to a reduction of the loan value;
receive a selected option from the list of selectable options; and
calculate the loan value based on the selected option.

31. The system as in claim 29, wherein the program further includes code adapted to:
access a realtor database;
retrieve a similar asset value for at least one similar asset; and
display the similar asset value as the asset value.
